(19) United States
(12) Patent Application Publication
(10) Pub. No.: US 2017/0142019 A1
(43) Pub. Date: May 18, 2017

(54) COMMUNICATION APPARATUS, COMMUNICATION SYSTEM, AND BANDWIDTH CONTROL METHOD

(71) Applicant: FUJITSU LIMITED, Kawasaki-shi (JP)

(72) Inventor: Kouichi IWATA, Fukuoka (JP)

(73) Assignee: FUJITSU LIMITED, Kawasaki-shi (JP)

(21) Appl. No.: 15/332,482

(22) Filed: Oct. 24, 2016

(30) Foreign Application Priority Data
Nov. 16, 2015 (JP) 2015-224064

(51) Int. Cl. H04L 12/825; H04L 12/851; H04L 12/26

(52) U.S. Cl. CPC H04L 47/25; H04L 43/0894; H04L 47/24

(57) ABSTRACT

An apparatus includes an obtainment circuit to measure first rates of traffics received from a previous node in a network, and second rates of traffics received from another apparatus connected to the communication apparatus, and to obtain sums of the first rates and the second rates for respective priorities; a calculation circuit to calculate discard rates for traffics for respective priorities from the sums obtained by the obtainment circuit and rates for traffics for the respective priorities posted by a subsequent node; and an output circuit to input the traffics received from the previous node and the another apparatus and to output for the subsequent node such that a certain traffic with a priority higher than a predetermined value is output more preferentially depending on the discard rate for the certain traffic, than a traffic with a priority lower than the predetermined value.

### CROSS-REFERENCE TO RELATED APPLICATION

This application is based upon and claims the benefit of priority of the prior Japanese Patent Application No. 2015-224064, filed on Nov. 16, 2015, the entire contents of which are incorporated herein by reference.

### FIELD

The embodiment discussed herein is related to a communication apparatus, a communication system, and a bandwidth control method.

### BACKGROUND

Ring networks each including multiple nodes connected in a ring shape have been known (see International Publication Pamphlet No. WO 2006/082652, and Japanese Laid-open Patent Publication No. 2011-193403, for example). Traffics to which classes representing priority levels are assigned are transmitted to the ring network, for example.

Traffics are input into each node from a terminal connected to the node, and from a previous node. For this reason, if there is an increase in the rates of the traffics input into the node from the terminal, for example, the sum of the rates of the traffics input into the node may exceed the maximum transmission bandwidth of the ring network. In this case, frame loss occurs in the node, and the rates of traffics output from the node to a subsequent node accordingly decrease.

Each node outputs traffics based on committed information rates (CIRs) set for the respective classes. However, portions of the traffics in excess of the committed information rates are output from the node regardless of their classes. For this reason, an output rate of even a traffic in a class given high priority (hereinafter referred to as a “high-priority traffic”) may decrease.

In contrast to this, if each node is configured to measure input rates of traffics received from a previous node and a terminal, as well as output rates of traffics output from the node to a subsequent node, the discard rates of the traffics in the respective classes may be calculated from the input rates and the output rates. This enables the high-priority traffics to be output preferentially according to the calculated discard rates, and thereby inhibits decreases in the output rates.

This case, however, involves a problem that the size of the hardware becomes larger because each node has to be provided with a counter for measuring the input rates and a counter for measuring the output rates.

### SUMMARY

According to an aspect of the embodiments, an apparatus includes an obtainment circuit configured to measure first rates of traffics received from a previous node in a network, and second rates of traffics received from another apparatus connected to the communication apparatus, and to obtain sums of the first rates and the second rates for respective priorities; a calculation circuit configured to calculate discard rates for traffics for respective priorities from the sums obtained by the obtainment circuit and rates for traffics for the respective priorities posted by a subsequent node; and an output circuit configured to input the traffics received from the previous node and the another apparatus and to output for the subsequent node such that a certain traffic with a priority higher than a predetermined value is output more preferentially depending on the discard rate for the certain traffic, than a traffic with a priority lower than the predetermined value.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a configuration diagram illustrating an example of a ring network;

FIG. 2 is a configuration diagram illustrating examples of a user frame;

FIG. 3 is a configuration diagram illustrating a communication apparatus of a first comparative example;

FIG. 4 is a diagram illustrating an example of bandwidth setting;

FIG. 5 is a configuration diagram illustrating examples of buffers;

FIG. 6 is a diagram illustrating examples of what traffic rates are when parts of traffics are discarded from the ring network;

FIG. 7 is a diagram illustrating an example of a traffic discarding process;

FIG. 8 is a configuration diagram illustrating a communication apparatus of a second comparative example;

FIG. 9 is a diagram illustrating another example of the traffic discarding process;

FIG. 10 is a diagram illustrating other examples of what the traffic rates are when parts of the traffics are discarded from the ring network;

FIG. 11A is a configuration diagram illustrating a ring continuity check (RCC) frame of the comparative example;

FIG. 11B is a configuration diagram illustrating an RCC frame of an example;

FIG. 12 is a configuration diagram illustrating a communication apparatus of the example; and

FIG. 13 is a flowchart illustrating how the communication apparatus of the example works.

### DESCRIPTION OF EMBODIMENT

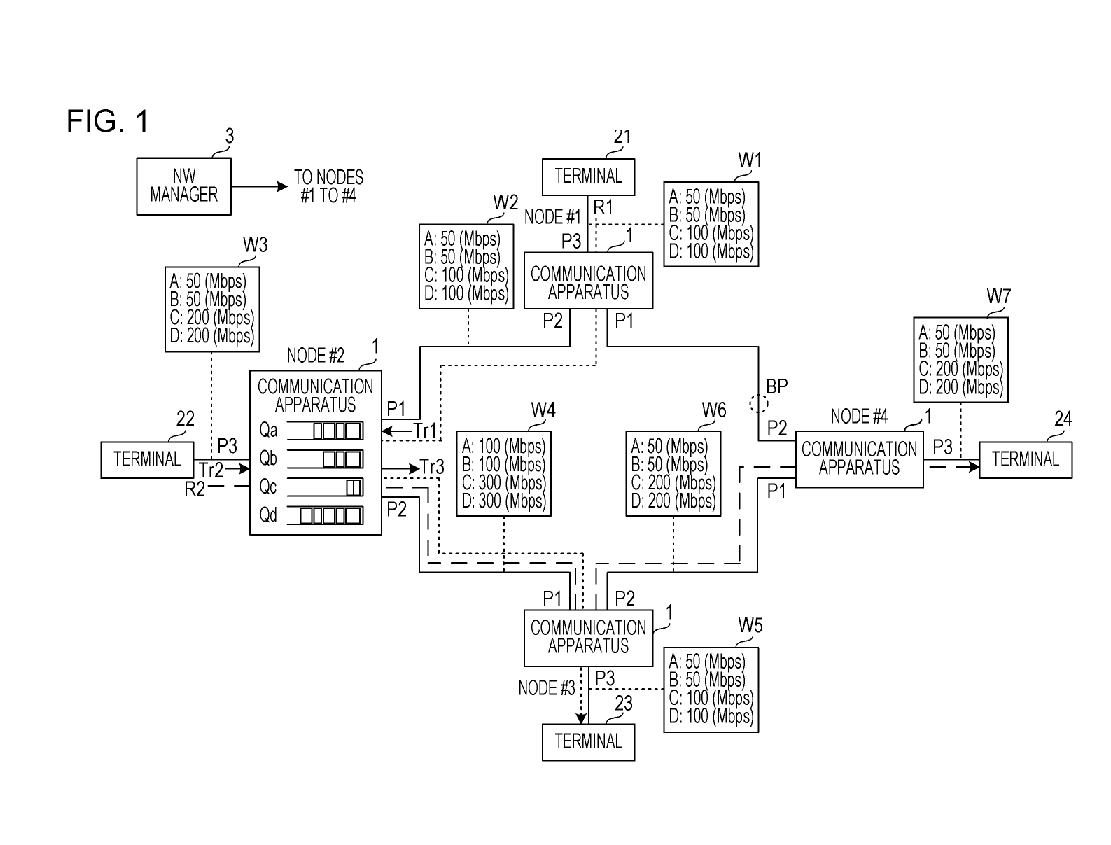

FIG. 1 is a configuration diagram illustrating an example of a ring network. The ring network is an example of a communication system. The ring network includes multiple nodes #1 to #4 connected together in a ring shape. The nodes #1 to #4 are each provided with a communication apparatus 1. Citable examples of the communication apparatus 1 include a router and a layer 2 switch. Nevertheless, the communication apparatus 1 is not limited to these examples. This embodiment cites the ring network as the network topology. Nevertheless, the network topology of the embodiment is not limited to the ring network. What will be discussed below is applicable to the nodes in a mesh network.

Terminals 21 to 24 are connected to the communication apparatuses 1 in the nodes #1 to #4, respectively. The terminals 21 to 24 transmit traffics to the other terminals 21 to 24 via the ring network. A citable example of the terminals 21 to 24 is a personal computer. Nevertheless, the terminals 21 to 24 are not limited to this example.

In addition, the communication apparatuses 1 in the nodes #1 to #4 are connected to a network (NW) manager 3 configured to control the ring network, for example via a local area network (LAN). The NW manager 3 sets bandwidths of the communication apparatuses 1 in the nodes #1 to #4. Incidentally, the bandwidth setting will be described later.

Furthermore, the NW manager 3 sets a blocking point BP in one of the communication apparatuses 1 in order to block perpetual flow of frames in the ring network. When reaching the blocking point BP, the frames are discarded. Incidentally, the frames used in the example are Ethernet (trademark, the same hereinafter). Nevertheless, the frames are not limited to them, and internet protocol (IP) packets may be used in the example.

The communication apparatus 1 includes multiple ports P1 to P3 through which to transmit and receive the frames to and from other apparatuses. The ports P1, P2 are connected respectively to the ports P2, P1 of the communication apparatuses 1 in the neighboring nodes #1 to #4, and the ports P3 are connected to the terminals 21 to 24. The blocking point BP is set at the port P2 of the communication apparatus 1 in the node #4, for example.

Thus, the terminal 21 in the node #1 transmits user frames to the terminal 23 in the node #3 along a route R1 (see dotted lines with a smaller pitch). The route R1 runs among the communication apparatuses 1 in the nodes #1 to #3 in this order.

Meanwhile, the terminal 22 in the node #2 transmits the user frames to the terminal 24 in the node #4 along a route R2 (see dotted lines with a larger pitch). The route R2 runs among the communication apparatuses 1 in the nodes #2 to #4 in this order. The user frames are input and output as traffics of the routes R1, R2 into and from the communication apparatuses 1 in the nodes #1 to #4.

For example, traffics Tr1 are input into the communication apparatus 1 in the node #2 from the communication apparatus 1 in the previous node #1, while traffics Tr2 are input into the communication apparatus 1 in the node #2 from the terminal 22 in the node #2. The communication apparatus 1 in the node #2 performs bandwidth control on the received traffics Tr1, Tr2, and outputs the resultant traffics as traffics Tr3 to the communication apparatus 1 in the subsequent node #3. Note that the following descriptions will be provided citing the configuration of the communication apparatus 1 in the node #2.

Classes representing priorities are assigned to the traffics transmitted to the ring network. For example, the class “A” represents the highest priority; the class “B” represents the second highest priority; the class “C” represents the third highest priority; and the class “D” represents the lowest priority. Each frame is given a tag representing the class assigned to the frame.

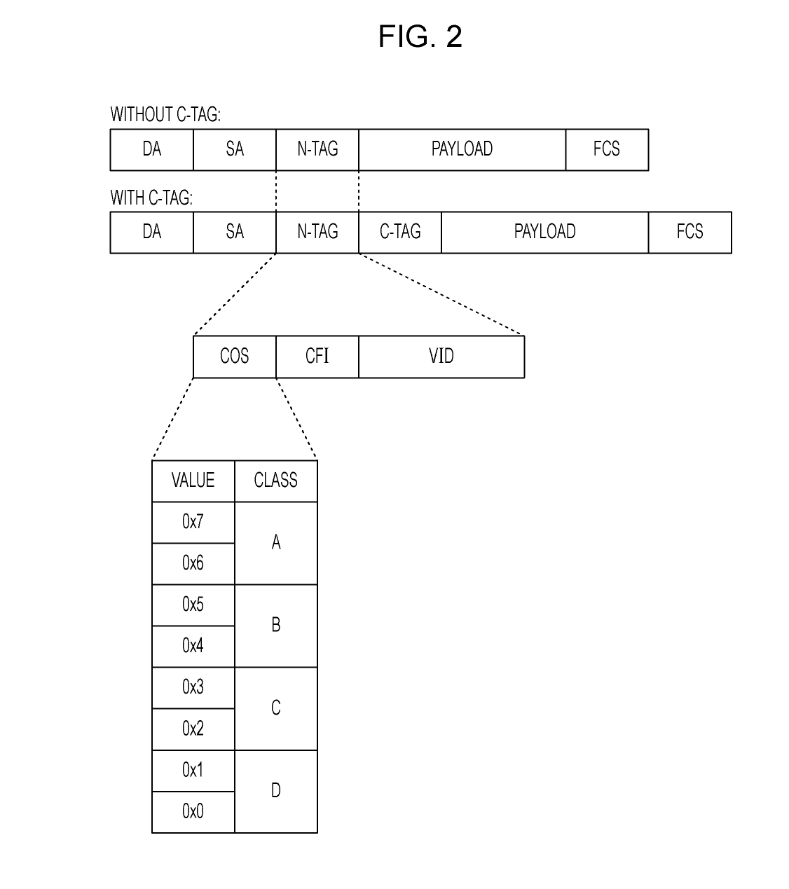

FIG. 2 is a configuration diagram illustrating examples of the user frame. Each user frame includes: a destination address (DA) representing a destination; a source address (SA) representing a sender; an N-TAG including information on the class and the like; a payload; and a frame check sequence (FCS) for data error detection. The user frames from the terminals 21 to 24 are classified into those including C-TAGs (see “with C-TAG”) and those including no C-TAGs (see “without C-TAG”).

N-TAGs are assigned to the user frames by the communication apparatuses 1 in the nodes #1 to #4. Each N-TAG includes a three-bit class of service (COS), a two-bit canonical format identifier (CFI), and a 12-bit virtual LAN identifier (VID). The COS represents a user frame class.

In a case where the value of the COS is 0x6 or 0x7 (where 0x represents the hexadecimal notation), the user frame class is “A”. In a case where the value of the COS is 0x4 or 0x5, the user frame class is “B”. In a case where the value of the COS is 0x2 or 0x3, the user frame class is “C”. In a case where the value of the COS is 0x0 or 0x1, the user frame class is “D”. Note that the VID and the CFI are used for the VLAN process.

C-TAGs are assigned to the user frames by the terminals 21 to 24. Each C-TAG also includes information similar to that included in the COS. Based on the information included in the C-TAG, each communication apparatus 1 sets the COS in the N-TAG. Note that in a case where each communication apparatus 1 receives a user frame without a C-TAG from the terminals 21 to 24, the communication apparatus 1 sets the COS as a class “D”.

Referring to FIG. 1 again, the communication apparatus 1 performs bandwidth control by storing each received frame into one of queues Qa to Qd depending on the class of the frame. As discussed below, a committed information rate is set for each class; and the communication apparatus 1 outputs traffics Tr3 for the classes with their respective committed information rates maintained. Meanwhile, portions of the traffics Tr3 in excess of the committed information rates are output as best-effort traffics, regardless of the classes “A” to “D”.

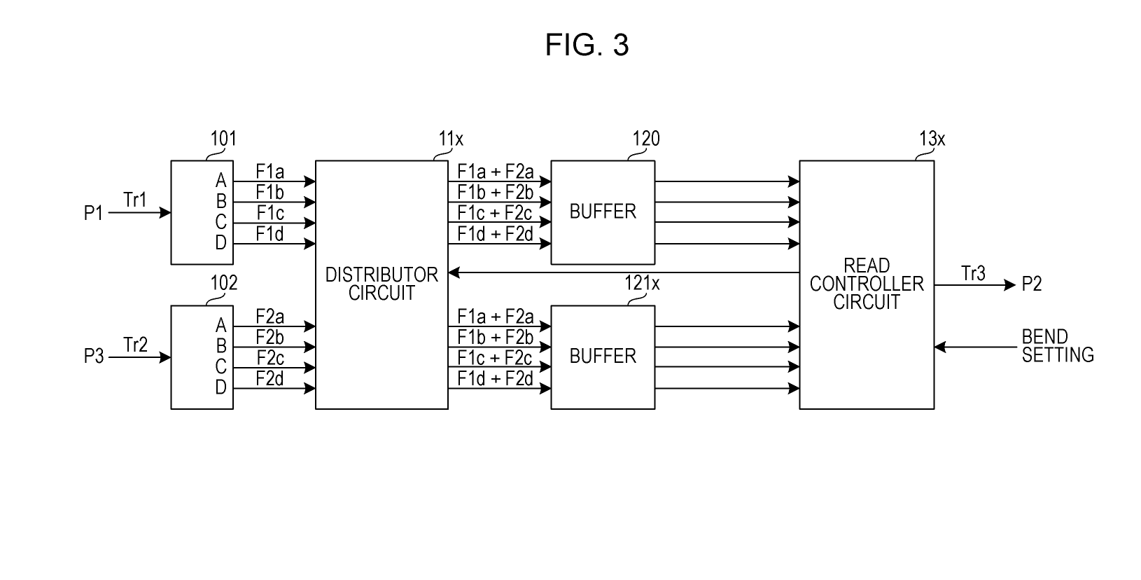

FIG. 3 is a configuration diagram illustrating a communication apparatus 1 of a first comparative example. The communication apparatus 1 includes classification circuits 101, 102, a distributor circuit 11x, buffers 120, 121x, and a read controller circuit 13x.

When receiving a traffic Tr1 from a port P1, the classification circuit 101 outputs the traffic Tr1 to the distributor circuit 11x by classifying the traffic Tr1 into one of the classes “A” to “D” based on the value of the COS in the user frame. To this end, user frames F1a to F1d of the classes “A” to “D” are individually output to the distributor circuit 11x.

Meanwhile, when receiving a traffic Tr2 from a port P3, the classification circuit 102 outputs the traffic Tr2 to the distributor circuit 11x by classifying the traffic Tr2 into one of the classes “A” to “D” based on the value of the COS in the user frame. To this end, the user frames F2a to F2d of the classes “A” to “D” are individually output to the distributor circuit 11x.

Under control of the read controller circuit 13x, the distributor circuit 11x distributes the user frames F1a to F1d, F2a to F2d to the buffers 120, 121x for the respective classes “A” to “D”. The buffer 120 stores the user frames F1a to F1d, F2a to F2d by their respective committed information rates. Meanwhile, the buffer 121x stores portions of the user frames F1a to F1d, F2a to F2d in excess of their respective committed information rates.

Based on the bandwidths set for the classes “A” to “D”, the read controller circuit 13x reads the user frames F1a to F1d, F2a to F2d from the buffers 120, 121x, and outputs the thus-read user frames F1a to F1d, F2a to F2d to the communication apparatus 1 in the node #3 via a port P2. The user frames F1a to F1d, F2a to F2d output from the read controller circuit 13x are the traffics Tr3.

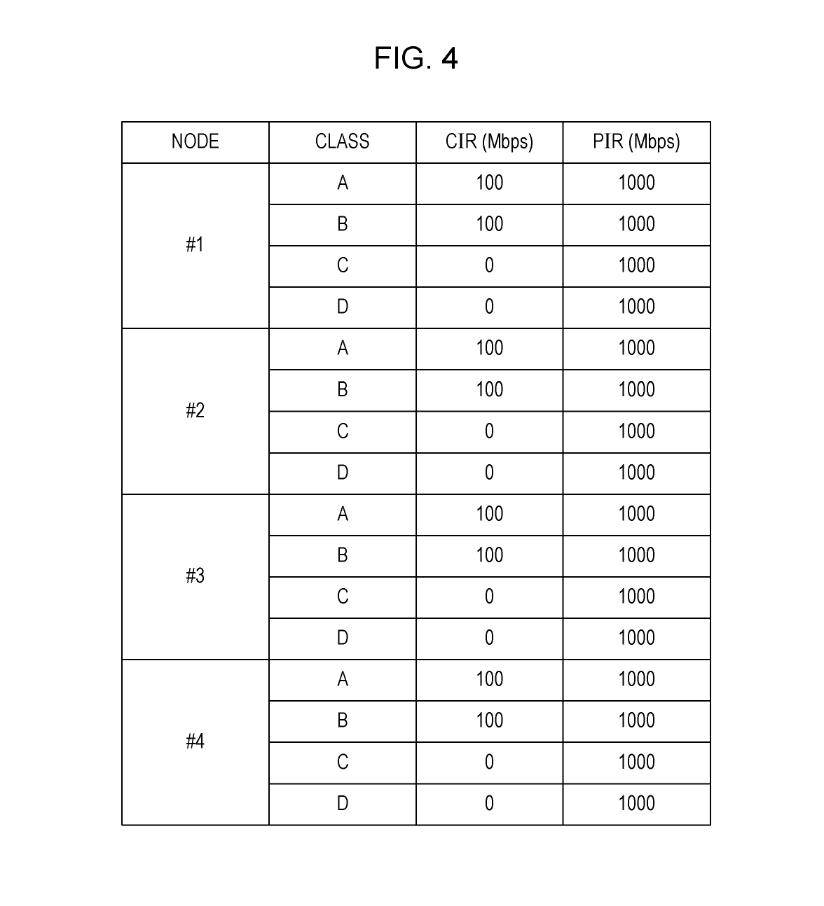

FIG. 4 illustrates an example of the bandwidth setting. As discussed above, the bandwidth setting is performed on the communication apparatuses 1 in the nodes #1 to #4 by the NW manager 3.

The bandwidth setting in each of the nodes #1 to #4 includes a CIR and a peak information rate (PIR) for each of the classes “A” to “D”. The CIRs represent the committed information rates set for the respective traffics Tr3 output from the communication apparatus 1. In this example, for the classes “A” and “B”, the communication apparatuses 1 in the nodes #1 to #4 each guarantee a bandwidth of at least 100 Mbps as the output rate of the traffic Tr3. Meanwhile, for the classes “C” and “D”, a bandwidth of at least 0 Mbps is guaranteed. In other words, no bandwidth is guaranteed for the classes “C” and “D”. For this reason, the input traffics Tr1, Tr2 in the classes “C” and “D” are output as those in the best-effort bandwidths.

Meanwhile, the PIR is the maximum value of an output rate tolerable for a portion of a traffic Tr3 in excess of the CIR. In this example, the communication apparatuses 1 in the nodes #1 to #4 may assign a bandwidth of 1000 Mbps, which is the maximum transmission capacity of the ring network, to portions of the traffics Tr3 in excess of the CIRs in the classes “A” to “D”. Nevertheless, since the CIR of 200 Mbps in total is assigned to the classes “A” and “B”, their actually usable bandwidths are 800 Mbps (equal to 1000 Mbps minus 200 Mbps).

In FIG. 1, reference signs W1 to W7 each illustrate traffic rates in the classes “A” to “D” in the corresponding section in the ring network. The reference sign W1 denotes the traffics input into the communication apparatus 1 from the terminal 21 in the node #1, and reference sign W2 denotes the traffics Tr1 input into the communication apparatus 1 in the node #2 from the communication apparatus 1 in the node #1. As indicated by reference signs W1 and W2, the traffic rates in the classes “A” and “B” are 50 Mbps each, and the traffic rates in the classes “C” and “D” are 100 Mbps each.

The reference sign W3 denotes the traffics Tr2 input into the communication apparatus 1 from the terminal 22 in the node #2. As indicated by reference sign W3, the traffic rates in the classes “A” and “B” are 50 Mbps each, and the traffic rates in the classes “C” and “D” are 200 Mbps each. The reference sign W4 denotes the traffics Tr3 input into the communication apparatus 1 in the node #3 from the communication apparatus 1 in the node #2. As indicated by reference sign W4, the traffic rates in the classes “A” and “B” are 100 Mbps each, and the traffic rates in the classes “C” and “D” are 300 Mbps each.

The reference sign W5 denotes the traffics input into the terminal 23 from the communication apparatus 1 in the node #3. As indicated by reference sign W5, the traffic rates in the classes “A” and “B” are 50 Mbps each, and the traffic rates in the classes “C” and “D” are 100 Mbps each. The reference sign W6 denotes the traffics input into the communication apparatus 1 in the node #4 from the communication apparatus 1 in the node #3. As indicated by reference sign W6, the traffic rates in the classes “A” and “B” are 50 Mbps each, and the traffic rates in the classes “C” and “D” are 200 Mbps each.

In addition, reference sign W7 denotes the traffics input into the terminal 24 from the communication apparatus 1 in the node #4. As indicated by reference sign W7, the traffic rates in the classes “A” and “B” are 50 Mbps each, and the traffic rates in the classes “C” and “D” are 200 Mbps each. In the case where the traffic rates are as indicated by reference signs W1 to W7, the communication apparatus 1 in the node #2 performs the following bandwidth control based on the bandwidth setting illustrated in FIG. 4.

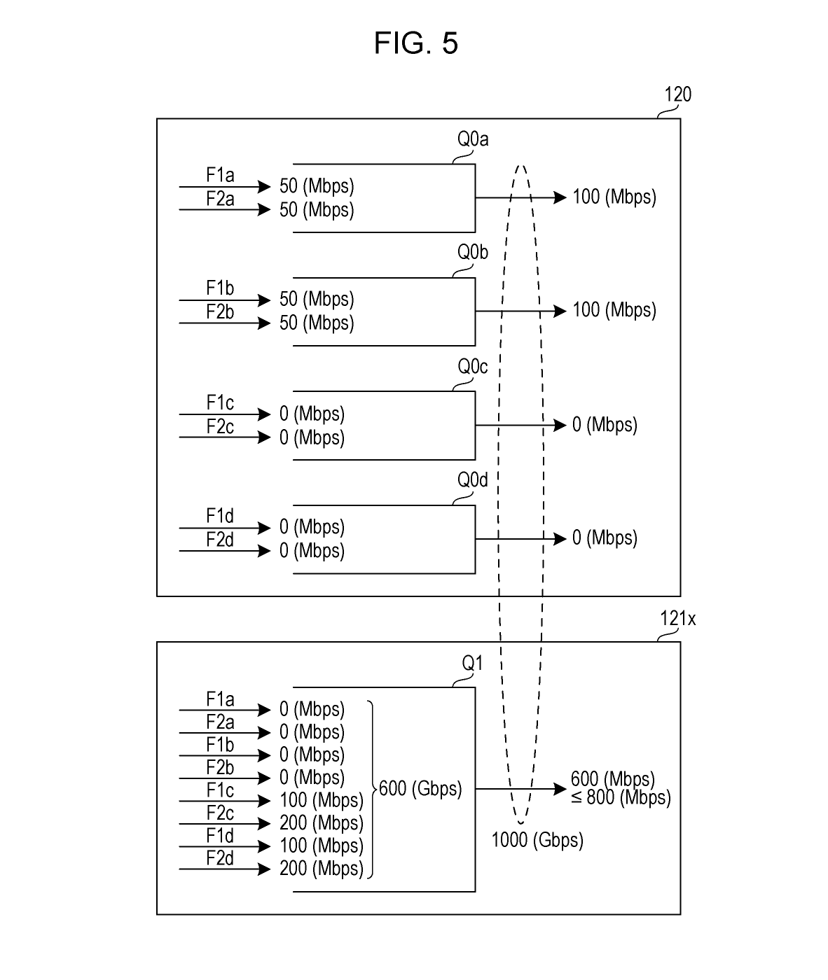

FIG. 5 is a configuration diagram illustrating examples of the buffers 120 and 121x. The buffer 120 includes queues Q0a to Q0d corresponding respectively to the classes “A” to “D”. Incidentally, the queues Q0a to Q0d correspond respectively to the queues Qa to Qd illustrated in FIG. 1.

The queue Q0a stores the user frames F1a, F1a of the traffics Tr1, Tr2 in the class “A” up to their CIR. The input rates of the traffics Tr1, Tr2 in the class “A” are 50 Mbps each. The sum of their input rates, which is 100 Mbps, is equal to or less than the CIR (100 Mbps) set for the bandwidth of the class “A”. Thus, the traffics Tr1, Tr2 in the class “A” are output as the traffic Tr3 from the queue Q0a without being discarded.

The queue Q0b stores the user frames F1b, F2b of the traffics Tr1, Tr2 in the class “B” up to their CIR. The input rates of the traffics Tr1, Tr2 in the class “B” are 50 Mbps each. The sum of their input rates, which is 100 Mbps, is equal to or less than the CIR (100 Mbps) set for the bandwidth of the class “B”. Thus, the traffics Tr1, Tr2 in the class “B” are output as the traffic Tr3 from the queue Q0b without being discarded.

The queue Q0c stores the user frames F1c, F2c of the traffics Tr1, Tr2 in the class “C” up to their CIR. However, since the CIR set for the bandwidth of the class “C” is 0 Mbps, neither of the traffics Tr1, Tr2 in the class “C” in this example is input into the queue Q0c. In other words, the rates of the traffics Tr1, Tr2 in the class “C” to be input into the queue Q0c are 0 Mbps each.

The queue Q0d stores the user frames F1d, F2d of the traffics Tr1, Tr2 in the class “D” up to their CIR. However, since the CIR set for the bandwidth of the class “D” is 0 Mbps, neither of the traffics Tr1, Tr2 in the class “D” in this example is input into the queue Q0d. In other words, the rates of the traffics Tr1, Tr2 in the class “D” to be input into the queue Q0d are 0 Mbps each.

Meanwhile, the buffer 121x is provided with a queue Q1 which is common among the classes “A” to “D”. In a case where the amounts of data in the user frames in the queues Q0a to Q0d in the buffer 120 reach values exceeding the CIRs set for the bandwidths, the read controller circuit 13x controls the distributor circuit 11x such that the distributor circuit 11x inputs the user frames in the classes “A” to “D” into the queue Q1. For this reason, regardless of the classes “A” to “D”, portions of the user frames F1a to F1d, F1a to F2d in excess of their respective CIRs are input into the queue Q1.

The bandwidth setting illustrated in FIG. 4 does not allow the user frames F1c, F1d, F2c, F2d in the classes “C” and “D” to be stored into the queues Q0c, Q0d in the buffer 120. Accordingly, all the traffics Tr1, Tr2 in the classes “C” and “D” are stored into the queue Q1.

The input rates of the traffics Tr1 in the classes “C” and “D” are 100 Mbps each. The input rates of the traffics Tr2 in the classes “C” and “D” are 200 Mbps each. Thus, their sum, which is 600 Mbps, is equal to or less than 800 Mbps which is the value obtained by subtracting 200 Mbps used for the CIRs from the PIR. Accordingly, the traffics Tr1, Tr2 in the classes “C” and “D” are output as the traffic Tr3 from the queue Q1 without being discarded. Note that the read controller circuit 13x reads the user frames F1c, F1d, F2c, F2d in the classes “C” and “D”, and outputs them from the queue Q1, for example in order of input.

In this example, none of the traffics Tr1, Tr2 in the classes “A” to “D” are discarded. However, in a case where, for example, the sum of the input rates of the traffics Tr1, Tr2 exceeds the maximum transmission capacity of the ring network, frame loss occurs to the communication apparatus 1 and the rate of output of the traffic Tr3 to the subsequent node #3 becomes lower, as discussed later.

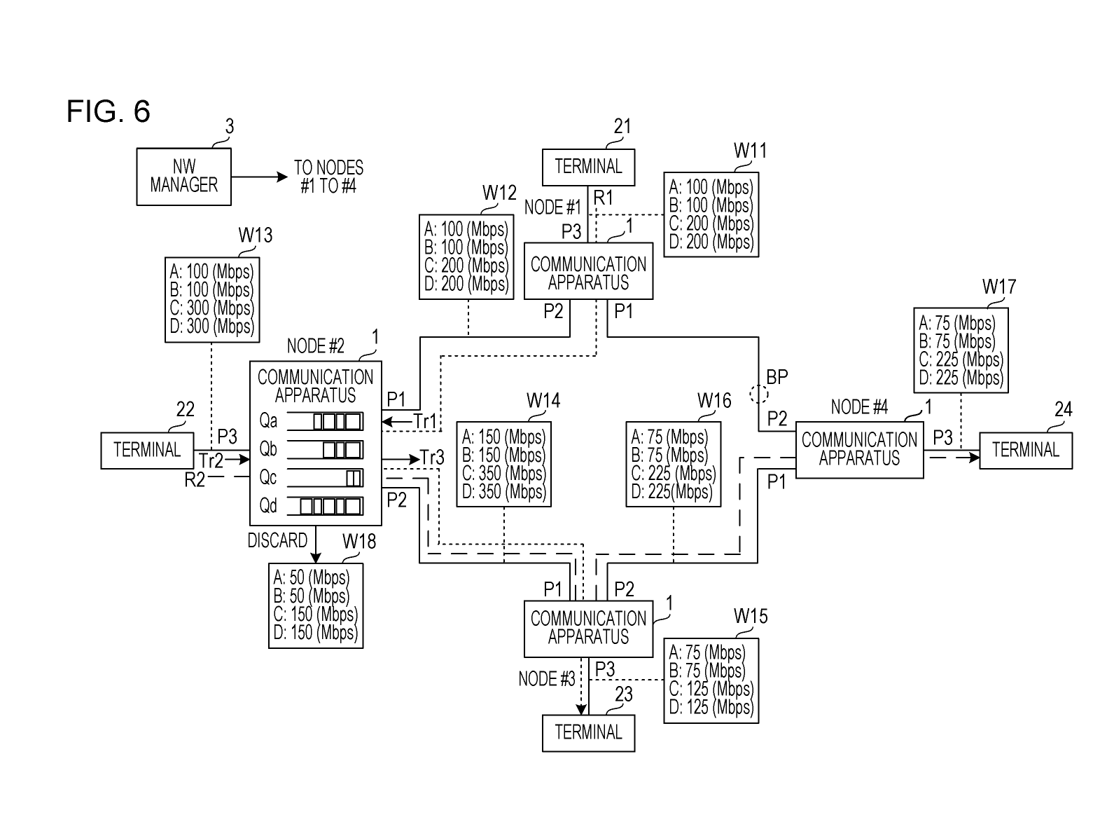

FIG. 6 illustrates examples of what the traffic rates are when portions of the traffics are discarded from the ring network. Common parts of the configuration between FIG. 6 and FIG. 1 are denoted by the same reference signs, and descriptions for the common parts are omitted. Reference signs W11 to W17 each illustrate traffic rates in the classes “A” to “D” in the corresponding section in the ring network.

The reference sign W11 denotes the traffics input into the communication apparatus 1 from the terminal 21 in the node #1, and reference sign W12 denotes the traffics Tr1 input into the communication apparatus 1 in the node #2 from the communication apparatus 1 in the node #1. As indicated by reference signs W11 and W12, the traffic rates in the classes “A” and “B” are 100 Mbps each, and the traffic rates in the classes “C” and “D” are 200 Mbps each.

The reference sign W13 denotes the traffics Tr2 input into the communication apparatus 1 from the terminal 22 in the node #2. As indicated by reference sign W13, the traffic rates in the classes “A” and “B” are 100 Mbps each, and the traffic rates in the classes “C” and “D” are 300 Mbps each. The reference sign W14 denotes the traffics Tr3 input into the communication apparatus 1 in the node #3 from the communication apparatus 1 in the node #2. As indicated by reference sign W14, the traffic rates in the classes “A” and “B” are 150 Mbps each, and the traffic rates in the classes “C” and “D” are 350 Mbps each.

The reference sign W15 denotes the traffics input into the terminal 23 from the communication apparatus 1 in the node #3. As indicated by reference sign W15, the traffic rates in the classes “A” and “B” are 75 Mbps each, and the traffic rates in the classes “C” and “D” are 125 Mbps each. The reference sign W16 denotes the traffics input into the communication apparatus 1 in the node #4 from the communication apparatus 1 in the node #3. As indicated by reference sign W16, the traffic rates in the classes “A” and “B” are 75 Mbps each, and the traffic rates in the classes “C” and “D” are 225 Mbps each.

In addition, reference sign W17 denotes the traffics input into the terminal 24 from the communication apparatus 1 in the node #4. As indicated by reference sign W17, the traffic rates in the classes “A” and “B” are 75 Mbps each, and the traffic rates in the classes “C” and “D” are 225 Mbps each.

In the case where the traffic rates are as indicated above, the sum of the input rates of the traffics Tr1, Tr2 in the communication apparatus 1 in the node #2 is 1400 Mbps, and exceeds 1000 Mbps which is the maximum transmission capacity of the ring network. Thus, as indicated by a reference sign W18, the communication apparatus 1 in the node #2 discards the traffics in the classes “A” and “B” by 50 Mbps each, and the traffics in the classes “C” and “D” by 150 Mbps each. To this end, the communication apparatus 1 performs the following bandwidth control based on the bandwidth setting illustrated in FIG. 4.

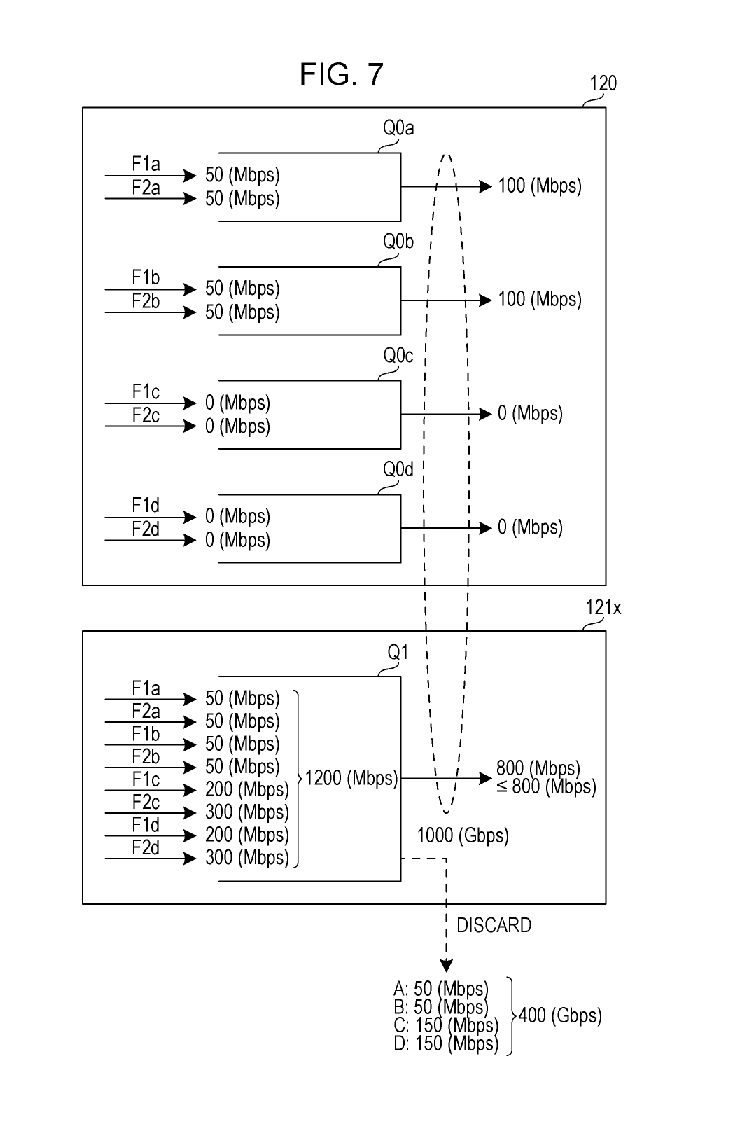

FIG. 7 illustrates an example of the traffic discarding process. Common parts of the configuration between FIG. 7 and FIG. 5 are denoted by the same reference signs, and descriptions for the common parts are omitted.

The traffics Tr1, Tr2 in the class “A” are input into the queue Q0a of the buffer 120 by a combined 100-Mbps CIR. For example, the user frames F1a, F1a are input into the queue Q0a by the 50-Mbps rate each.

The traffics Tr1, Tr2 in the class “B” are input into the queue Q0b by a combined 100-Mbps CIR. For example, the user frames F1b, F2b are input into the queue Q0b by the 50-Mbps rate each. Incidentally, the traffics Tr1, Tr2 in the classes “C” and “D” are not input into the queues Q0c, Q0d, since their CIRs are 0 Mbps.

In addition, the remains of the traffics Tr1, Tr2 in the classes “A” and “B” and all the traffics Tr1, Tr2 in the classes “C” and “D” are input into the queue Q1 of the buffer 121x. To put it more specifically, the user frames F1a, F1a F1b, F2b in the classes “A” and “B” are input into the queue Q1 by the 50-Mbps rate each. Furthermore, the user frames F1c, F1d in the classes “C” and “D” are input into the queue Q1 by the 200-Mbps rate each, while the user frames F2c, F2d in the classes “C” and “D” are input into the queue Q1 by the 300-Mbps rate each.

In sum, the traffics Tr1, Tr2 with a combined total of 1200 Mbps are input into the queue Q1. In that case, the traffics Tr1, Tr2 are discarded by 400 Mbps (equal to 1200 Mbps minus 800 Mbps) since the output rate tolerable to the queue Q1 is 800 Mbps obtained by subtracting 200 Mbps, which is the sum of the used CIRs, from the 1000-Mbps PIR (see “Discard”).

The discarding process is randomly performed on the traffics Tr1, Tr2 regardless of the classes “A” to “D”. For this reason, although given high priority, the traffics in the classes “A” and “B” are discarded, for example by 50 Mbps each, and their output rates thus become lower. Meanwhile, the low-priority traffics in the classes “C” and “D” are discarded by 150 Mbps each.

However, it is desirable that regardless of the best-effort bandwidth control, the high-priority traffics be output more preferentially than the lower-priority traffics. With this taken into consideration, the communication apparatus 1 of a second comparative example is configured to: measure the input rates of the traffics Tr1, Tr2 input from the communication apparatus 1 in the previous node #1 and the terminal 22 as well as the output rates of the traffics Tr3 output to the communication apparatus 1 in the subsequent node #3; and calculate the discard rates for the traffics Tr3 in the classes “A” to “D” from the input rates and the output rates. This configuration makes it possible for the communication apparatus 1 to output the high-priority traffics preferentially depending on the calculated discard rates, and accordingly to inhibit the decreases in the output rates of the higher-priority traffics.

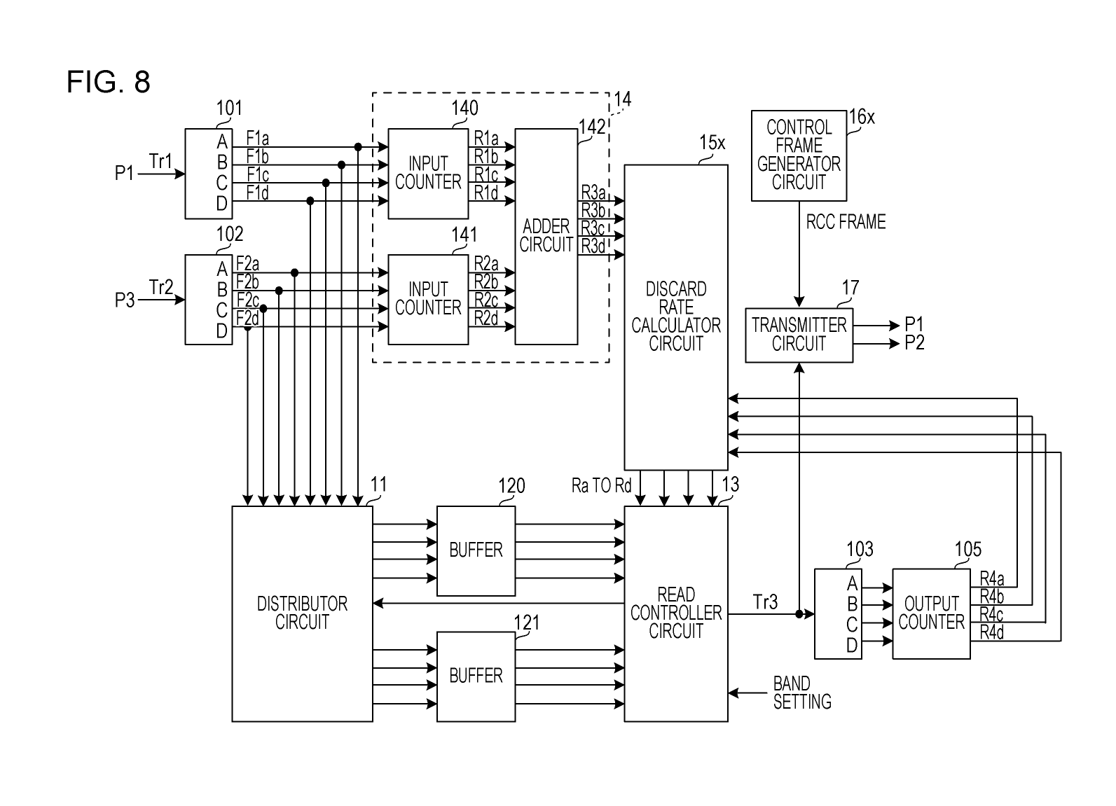

FIG. 8 is a configuration diagram illustrating the communication apparatus 1 of the second comparative example. Common parts of the configuration between FIG. 8 and FIG. 3 are denoted by the same reference signs, and descriptions for the common parts are omitted.

The communication apparatus 1 includes classification circuits 101 to 103, a distributor circuit 11, buffers 120, 121, a read controller circuit 13, an input rate obtaining circuit 14, a discard rate calculator circuit 15x, a control frame (FRM) generator circuit 16x, a transmitter circuit 17, and an output counter 105. The input rate obtaining circuit 14 includes input counters 140, 141, and an adder circuit 142.

Under control of the read controller circuit 13, the distributor circuit 11 distributes the user frames F1a to F1d, F2a to F2d to the buffers 120, 121 for the respective classes “A” to “D”. The buffer 120 stores the user frames F1a to F1d, F2a to F2d by their respective committed information rate (CIR). The buffer 121 stores portions of the user frames F1a to F1d, F2a to F2d in excess of their respective committed information rates.

The read controller circuit 13 is an example of an output circuit. Based on the bandwidths set for the classes “A” to “D”, the read controller circuit 13 reads the user frames F1a to F1d, F2a to F2d from the buffers 120, 121, and outputs the thus-read user frames F1a to F1d, F2a to F2d from the port P2 to the communication apparatus 1 in the node #3 via the transmitter circuit 17. The user frames F1a to F1d, F2a to F2d output from the read controller circuit 13 are the traffics Tr3. In other words, the read controller circuit 13 receives the traffics Tr1, Tr2 from the previous node #1 and the terminal 22, and outputs the thus-received traffics Tr1, Tr2 to the communication apparatus 1 in the subsequent node #2.

The input rate obtaining circuit 14 is an example of an obtainment circuit. The input rate obtaining circuit 14 measures rates R1a to R1d of the traffics Tr1 received from the communication apparatus 1 in the previous node #1 in the ring network, and rates R2a to R2d of the traffics Tr2 received from the terminal 22 connected to the communication apparatus 1. The input rate obtaining circuit 14 obtains the sums R3a to R3d of the rates R1a to R1d and the rates R2a to R2d in the classes “A” to “D”, respectively.

The input counter 140 is an example of a measurement circuit. The input counter 140 measures the rates R1a to R1d of the traffics Tr1, received from the communication apparatus 1 in the previous node #1, according to the classes “A” to “D”. To put it more specifically, the input counter 140 counts the byte counts of the user frames F1a to F1d in the classes “A” to “D”, received from the communication apparatus 1 in the node #1, at predetermined intervals. Based on the thus-counted byte counts, the input counter 140 measures the rates R1a to R1d of the user frames F1a to F1d, and posts the thus-measured rates R1a to R1d to the adder circuit 142.

Meanwhile, the input counter 141 measures the rates R2a to R2d of the traffics Tr2, received from the terminal 22 in the node #2, according to the classes “A” to “D”. To put it more specifically, the input counter 141 counts the byte counts of the user frames F2a to F2d in the classes “A” to “D”, received from the terminal 22, at predetermined intervals. Based on the thus-counted byte counts, the input counter 141 measures the rates R2a to R2d of the user frames F2a to F2d, and posts the thus-measured rates R2a to R2d to the adder circuit 142.

The adder circuit 142 includes adders respectively for the classes “A” to “D”. The adder circuit 142 adds up the rates R1a to R1d of the traffics Tr1 and the rates R2a to R2d of the traffics Tr2 according to the classes “A” to “D”, respectively. Thereby, the adder circuit 142 obtains the sums R3a to R3d of the input rates of the traffics Tr1 and the input rates of the traffics Tr2 in the classes “A” to “D,” respectively.

The sum R3a of the input rates of the traffics Tr1, Tr2 in the class “A” is obtained by adding up the rates R1a, R2a of the user frames F1a, F2a. The sum R3b of the input rates of the traffics Tr1, Tr2 in the class “B” is obtained by adding up the rates R1b, R2b of the user frames F1b, F2b.

Furthermore, the sum R3c of the input rates of the traffics Tr1, Tr2 in the class “C” is obtained by adding up the rates R1c, R2c of the user frames F1c, F2c. The sum R3d of the input rates of the traffics Tr1, Tr2 in the class “D” is obtained by adding up the rates R1d, R2d of the user frames F1d, F2d. The adder circuit 142 posts the thus-obtained sums R3a to R3d of the input rates of the traffics Tr1 and the input rates of the traffics Tr2 in the classes “A” to “D” to the discard rate calculator circuit 15x.

Moreover, based on the COSs, the classification circuit 103 classifies the traffics Tr3, read from the read controller circuit 13 and output from the port P2, into the classes “A” to “D”, as well as outputs the resultant classifications to the output counter 105. For the classes “A” to “D”, the output counter 105 measures rates R4a to R4d of the traffics Tr3, respectively.

To put it more specifically, the output counter 105 counts the byte counts of the user frames F1a to F1d, F2a to F2d in the classes “A” to “D”, received from the communication apparatus 1 in the node #1, at predetermined intervals. Based on the thus-counted byte counts, the output counter 105 measures the rates R4a to R4d of the user frames F1a to F1d, F2a to F2d, and posts the thus-measured rates R4a to R4d to the discard rate calculator circuit 15x.

Based on the input rate sums R3a to R3d posted from the adder circuit 142 and the output rates R4a to R4d posted from the output counter 105, the discard rate calculator circuit 15x calculates discard rates Ra to Rd for the traffics Tr1, Tr2 in the classes “A” to “D”. For example, based on the output rates R4a to R4d and the input rate sums R3a to R3d, the discard rate calculator circuit 15x calculates the discard rates Ra to Rd for the classes “A” to “D”. The discard rate calculator circuit 15x posts the thus-calculated discard rates Ra to Rd to the read controller circuit 13.

Depending on the discard rates Ra to Rd posted from the discard rate calculator circuit 15x, the read controller circuit 13 performs the priority control on the high-priority traffics Tr1, Tr2. Depending on the discard rates Ra, Rb for the classes “A” and “B”, the read controller circuit 13 outputs the traffics Tr1, Tr2 in the classes “A” and “B” more preferentially than the traffics Tr1, Tr2 in the classes “C” and “D”.

Thus, depending on the discard rates Ra to Rd, the read controller circuit 13 is capable of inhibiting the decreases in the output rates R4a, R4b of the traffics Tr1, Tr2 in the classes “A” and “B”. Note that although in the example, the read controller circuit 13 handles the traffics Tr1, Tr2 in the class “B” and the higher class as the high-priority traffics, the priority control performed by the read controller circuit 13 is not limited to this case. The read controller circuit 13 may be configured to handle only the traffics Tr1, Tr2 in the class “A” as the high-priority traffics.

To put it more specifically, in case where the discard rates Ra, Rb for the classes “A” and “B” are respectively equal to or greater than fixed values Ka, Kb, the read controller circuit 13 outputs the traffics Tr1, Tr2 in the classes “A” and “B” more preferentially than the traffics Tr1, Tr2 in the classes “C” and “D”. Accordingly, in a case where the discard rates Ra, Rb increase to be equal to or greater than the fixed values Ka, Kb, the read controller circuit 13 is capable of inhibiting the decreases in the output rates R4a, R4b of the traffics Tr1, Tr2 in the classes “A” and “B”.

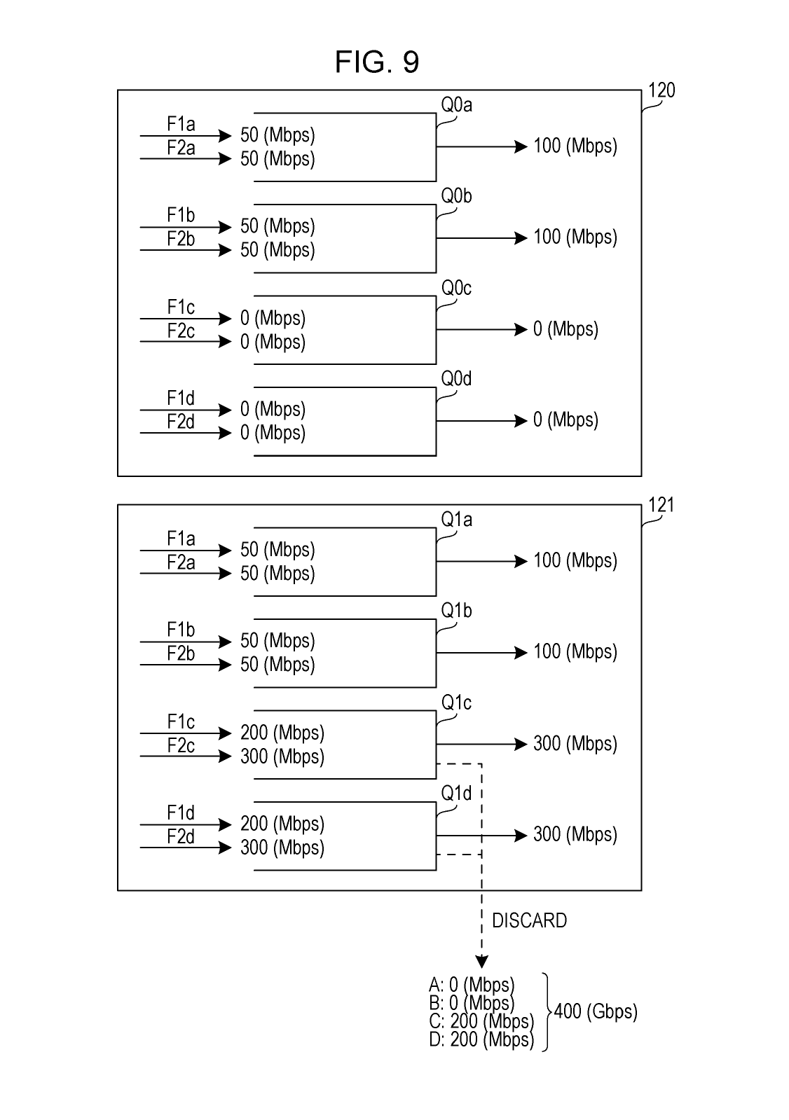

FIG. 9 illustrates the traffic discarding process of the example. Common parts of the configuration between FIG. 9 and FIG. 5 are denoted by the same reference signs, and descriptions for the common parts are omitted.

As discussed referring to FIG. 7, the traffics Tr1, Tr2 in the classes “A” and “B” are input into the queues Q0a, Q0b in the buffer 120 by 100 Mbps according to the CIRs.

Meanwhile, the buffer 121 includes queues Q1a to Q1d for the classes “A” to “D”, respectively. The portions of the traffics Tr1, Tr2 in the classes “A” to “D” in excess of their CIRs are input into the queues Q1a to Q1d. Note that the queues Q1a to Q1d correspond respectively to the queues Qa to Qd illustrated in FIG. 1.

The user frames F1a, F2a in the traffics Tr1, Tr2 in the class “A” are input into the queue Q1a. When the discard rate Ra the fixed value Ka, the read controller circuit 13 outputs the user frames F1a, F2a in the class “A” more preferentially than the user frames F1c, F2c, F1d, F2d in the classes “C” and “D”.

Thus, the user frames F1a, F2a in the class “A” are each input into the queue Q1a by a 50-Mbps rate obtained by excluding the corresponding CIR, and are output together from the queue Q1a by a combined 100-Mbps rate. Thus, the traffics Tr1, Tr2 in the class “A” are output without being discarded, and a decrease in the output rate R4a is accordingly inhibited.

The user frames F1b, F2b in the traffics Tr1, Tr2 in the class “B” are input into the queue Q1b. When the discard rate Rb the fixed value Kb, the read controller circuit 13 outputs the user frames F1b, F2b in the class “B” more preferentially than the user frames F1c, F2c, F1d, F2d in the classes “C” and “D”.

Thus, the user frames F1b, F2b in the class “B” are each input into the queue Q1b by a 50-Mbps rate obtained by excluding the corresponding CIR, and are output together from the queue Q1b by a combined 100-Mbps rate. Thus, the traffics Tr1, Tr2 in the class “B” are output without being discarded, and the decrease in the output rate R4b is accordingly inhibited.

Furthermore, the user frames F1c, F2c in the traffics Tr1, Tr2 in the class “C” are input into the queue Q1c. When the discard rate Ra the fixed value Ka, the read controller circuit 13 processes the output of the user frames F1c, F2c in the class “C” less preferentially than the output of the user frames F1a, F2a in the class “A”. In addition, when the discard rate Rb the fixed value Kb, the read controller circuit 13 processes the output of the user frames F1c, F2c in the class “C” less preferentially than the output of the user frames F1b, F2b in the class “B”.

Thus, the user frames F1c, F2c in the class “C” are input into the queue Q1c respectively by a 200-Mbps rate and by a 300-Mbps rate (or by a combined 500-Mbps rate). However, parts of the user frames F1c, F2c in the class “C” are discarded. Accordingly, the user frames F1c, F2c in the class “C” are output from the queue Q1c by a combined 300-Mbps rate only. In other word, in the queue Q1c, the traffics Tr1, Tr2 in the class “C” are discarded by a combined 200-Mbps rate (see “Discard”).

Furthermore, the user frames F1d, F2d in the traffics Tr1, Tr2 in the class “D” are input into the queue Q1d. When the discard rate Ra the fixed value Ka, the read controller circuit 13 processes the output of the user frames F1d, F2d in the class “D” less preferentially than the output of the user frames F1a, F2a in the class “A”. In addition, when the discard rate Rb the fixed value Kb, the read controller circuit 13 processes the output of the user frames F1d, F2d in the class “D” less preferentially than the output of the user frames F1b, F2b in the class “B”.

Thus, the user frames F1d, F2d in the class “D” are input into the queue Q1d respectively by a 200-Mbps rate and by a 300-Mbps rate (or by a combined 500-Mbps rate). However, parts of the user frames F1d, F2d in the class “D” are discarded. Accordingly, the user frames F1d, F2d in the class “D” are output from the queue Q1d by a combined 300-Mbps rate only. In other word, in the queue Q1d, the traffics Tr1, Tr2 in the class “D” are discarded by a combined 200-Mbps rate.

As discussed above, the read controller circuit 13 performs the priority control on the traffics Tr1, Tr2 in the class “A” when the discard rate Ra the fixed value Ka, and performs the priority control on the traffics Tr1, Tr2 in the class “B” when the discard rate Rb the fixed value Kb. Thereby, the read controller circuit 13 inhibits the decreases in the output rates R4a, R4b of the traffics Tr1, Tr2 in the class “A” or the class “B”.

Furthermore, when the discard rate Ra<the fixed value Ka, the read controller circuit 13 processes the output of the traffics Tr1, Tr2 in the class “A” with the same priority as the output of the traffics Tr1, Tr2 in other classes “C” and “D” instead of performing the priority control on the traffics Tr1, Tr2 in the class “A”. To put it more specifically, the read controller circuit 13 outputs the user frames F1a, F1a, F1c, F2c, F1d, F2d in the traffics Tr1, Tr2 in the classes “A”, “C” and “D” in order of arrival. Note that when the discard rate Rb<the fixed value Kb, the read controller circuit 13 handles the traffics Tr1, Tr2 in the class “B” in the same manner as in the case of the class “A”.

As discussed above, when the discard rates Ra, Rb for the classes “A” and “B” are respectively less than the fixed values Ka, Kb, the read controller circuit 13 outputs, regardless of the priorities assigned to the classes “A” to “D”, portions of the traffics Tr1, Tr2 in the classes “A” and “B” in excess of the CIRs set for the classes “A” and “B”. Thus, when their input rates exceed the CIRs, the traffics Tr1, Tr2 in the classes “A” to “D” are allowed to use a bandwidth obtained by excluding the CIRs from the transmission bandwidth of the ring network without being hindered because of the class.

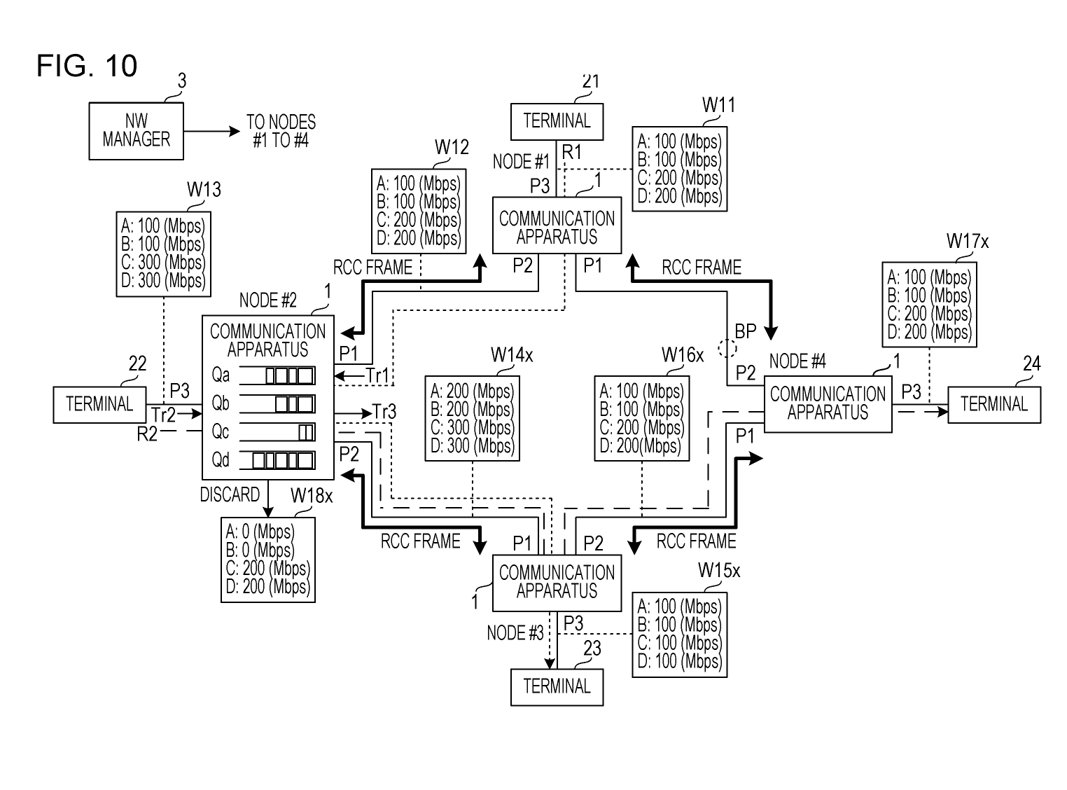

FIG. 10 illustrates the traffic rates in the ring network of the example. Common parts of the configuration between FIG. 10 and FIG. 6 are denoted by the same reference signs, and descriptions for the common parts are omitted. Reference signs W11 to W13, W14x to W17x each illustrate traffic rates in the classes “A” to “D” in the corresponding section in the ring network.

The reference sign W14x denotes the traffics Tr3 input into the communication apparatus 1 in the node #3 from the communication apparatus 1 in the node #2. As indicated by reference sign W14x, the traffic rates in the classes “A” and “B” are 200 Mbps each, and the traffic rates in the classes “C” and “D” are 300 Mbps each. In this case, as indicated by a reference sign W18x, the communication apparatus 1 in the node #2 discards the traffics in the classes “C” and “D” by 200 Mbps each, but not the traffics in the classes “A” and “B”, as discussed above. Thereby, the decreases in the output rates of the traffics in the classes “A” and “B” are inhibited.

Meanwhile, reference sign W15x denotes the traffics input into the terminal 23 from the communication apparatus 1 in the node #3. As indicated by reference sign W15x, the traffic rates in the classes “A” and “B” are 100 Mbps each, and the traffic rates in the classes “C” and “D” are 100 Mbps each. Thus, the traffic rates in the classes “A” and “B” input into the terminal 23 in the node #3 are greater than those illustrated in FIG. 6 by 25 Mbps each.

In addition, reference sign W16x denotes the traffics input into the communication apparatus 1 in the node #4 from the communication apparatus 1 in the node #3. As indicated by reference sign W16x, the traffic rates in the classes “A” and “B” are 100 Mbps each, and the traffic rates in the classes “C” and “D” are 200 Mbps each. Thus, the traffic rates in the classes “A” and “B” input into the communication apparatus 1 in the node #4 are greater than those illustrated in FIG. 6 by 25 Mbps each.

Furthermore, reference sign W17x denotes the traffics input into the terminal 24 from the communication apparatus 1 in the node #4. As indicated by reference sign W17x, the traffic rates in the classes “A” and “B” are 100 Mbps each, and the traffic rates in the classes “C” and “D” are 200 Mbps each. Thus, the traffic rates in the classes “A” and “B” input into the terminal 24 in the node #4 are greater than those illustrated in FIG. 6 by 25 Mbps each.

Since as discussed above, the communication apparatus 1 in the node #2 of the example outputs the traffic rates in the classes “A” and “B” preferentially depending on the discard rates Ra, Rb, the rates of the traffic rates in the classes “A” and “B” are generally greater than those illustrated in FIG. 6.

Moreover, in the example, the communication apparatuses 1 in the respective nodes #1 to #4 transmit and receive an RCC frame. The RCC frame is transmitted to and received by each neighboring two of the nodes #1 to #4, and is used to check whether or not the neighboring two of the nodes #1 to #4 are connected to each other.

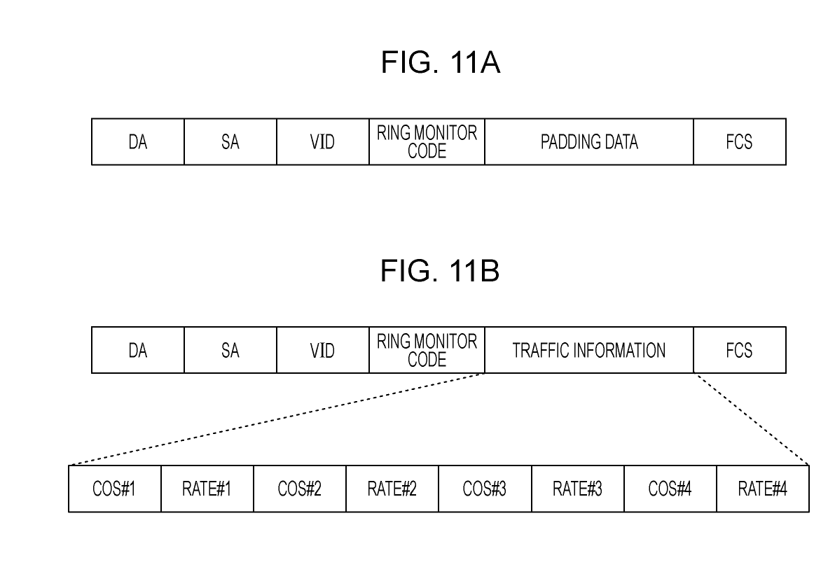

FIG. 11A is a configuration diagram illustrating the RCC frame of the comparative example. The RCC frame includes the DA, the SA, the VID, a ring monitor code, padding data, and the FCS. The DA, the SA, the VID and the FCS are as discussed above.

The ring monitor code includes a code for the continuity check (CC), a ring ID, and the like. Meanwhile, the padding data is fixed pattern data given to set the data amount (frame length) of the RCC frame at a predetermined value.

At predetermined intervals, the control frame (FRM) generator circuit 16x illustrated in FIG. 8 generates the RCC frame, and outputs it to the transmitter circuit 17. Receiving the RCC frame from the control frame generator circuit 16x and the user frames F1a to F1d, F2a to F2d from the read controller circuit 13, the transmitter circuit 17 transmits them to the other nodes #1, #3, #4.

To put it more specifically, the transmitter circuit 17 transmits the RCC frame to the nodes #1, #3 adjacent to its own node #2 via the respective ports P1, P2, and the user frames F1a to F1d, F2a to F2d to the communication apparatus 1 in the node #3 via the port P2. The transmitter circuit 17 transmits the RCC frame more preferentially than the user frames F1a to F1d, F2a to F2d, for example.

The communication apparatus 1 of the second comparative example is capable of outputting the traffics in the classes “A” and “B” preferentially, but requests larger-size hardware since it requests to be provided with the input counters 140, 141 and the output counter 105.

With this taken into consideration, the communication apparatus 1 of the example is designed to: receive the output rates of the traffics Tr3 posted in the form of the RCC frames from the subsequent nodes #1 to #4 instead of measuring the output rates using the output counter 105; and calculate the discard rates for the classes “A” to “D” from the output rates and the input rates. Thereafter, the communication apparatus 1 of the example outputs the high-priority traffics in the classes “A” and “B” preferentially depending on the discard rates in the same manner as does the communication apparatus 1 of the second comparative example. Thereby, it is possible to achieve the priority control to be performed on the high-priority traffics using a smaller-sized hardware configuration which is obtained by excluding the output counter 105.

FIG. 11B is a configuration diagram illustrating the RCC frame of the example. The RCC frame is an example of the control frame. The RCC frame includes the DA, the SA, the VID, the ring monitor code, traffic information, and the FCS. The DA, the SA, the VID, the ring monitor code, and the FCS are as discussed above.

The traffic information includes COSs #1 to #4 and rates #1 to #4. The COSs #1 to #4 represent the classes “A” to “D”, like the values of the COS illustrated in FIG. 2. The rates #1 to #4 are input rates of the traffics Tr1 corresponding to the COSs #1 to #4, respectively. In the case where the COSs #1 to #4 correspond respectively to the classes “A” to “D”, the rates #1 to #4 represent the input rates of the traffics Tr1 in the classes “A” to “D”.

For each of the classes “A” to “D”, the communication apparatuses 1 in the nodes #1 to #4 measure the input rates of the traffics Tr1 received from the communication apparatuses 1 in the previous nodes #4, #1 to #3. Then, the communication apparatus 1 in the nodes #1 to #4 each insert the input rates of the traffics Tr1 into the fields assigned to the rates #1 to #4 in the RCC frame. Thereafter, the communication apparatus 1 in the nodes #1 to #4 transmit their RCC frames to the communication apparatuses 1 in the previous nodes. For this reason, the communication apparatuses 1 in the nodes #1 to #4 each may not measure the output rates of the traffics Tr3 using the output counter 105, and are capable of obtaining the output rates from the RCC frames received from the communication apparatuses 1 in the subsequent nodes #2 to #4, #1.

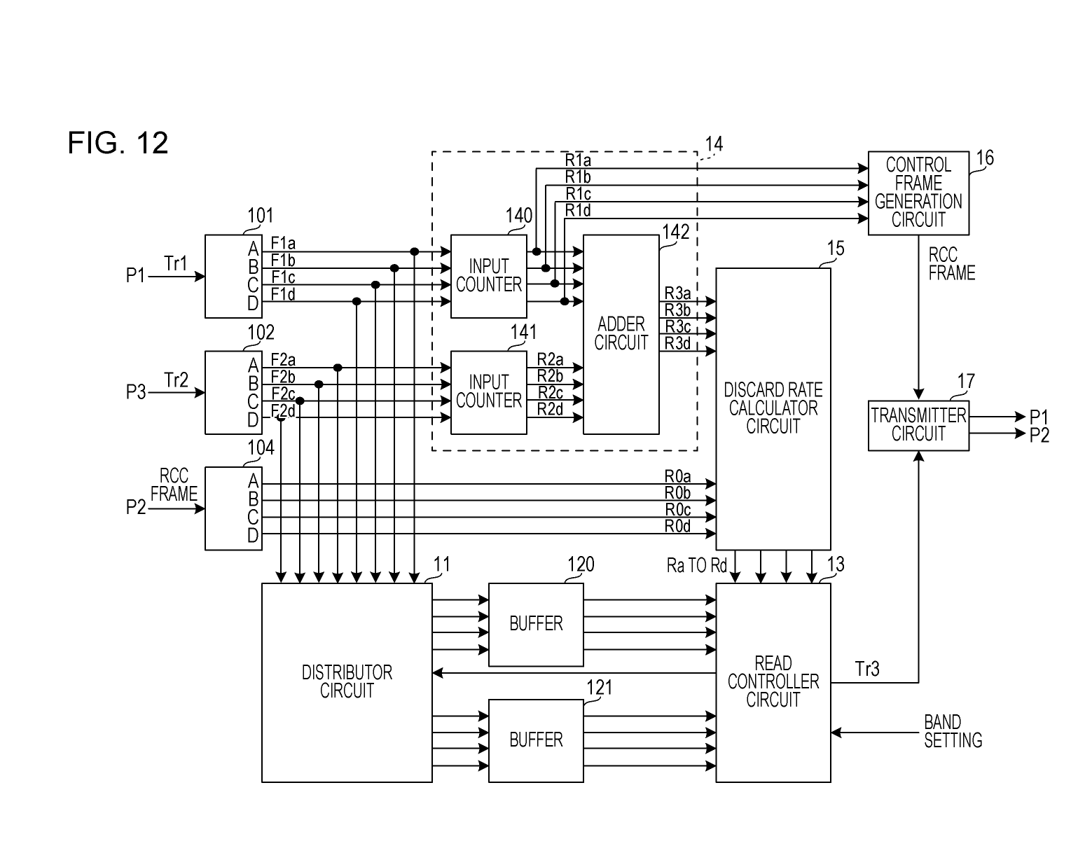

FIG. 12 is a configuration diagram illustrating the communication apparatus 1 of the example. Common parts of the configuration between FIG. 12 and FIGS. 3 and 8 are denoted by the same reference signs, and descriptions for the common parts are omitted.

The communication apparatus 1 includes the classification circuits 101, 102, an output rate obtaining circuit 104, the distributor circuit 11, the buffers 120, 121, the read controller circuit 13, the input rate obtaining circuit 14, a discard rate calculator circuit 15, a control frame generator circuit 16, and the transmitter circuit 17. The input rate obtaining circuit 14 includes the input counters 140, 141, and the adder circuit 142.

The communication apparatus 1 of the example is provided with no output counter 105, as learned from the comparison with the second comparative example illustrated in FIG. 8. The communication apparatus 1 obtains the output rates of the traffics Tr3, which is output from the communication apparatus 1, using the output rate obtaining circuit 104 instead of using the output counter 105.

The output rate obtaining circuit 104 receives the RCC frame from the communication apparatus 1 in the subsequent node #3 which is an example of a first communication apparatus, and obtains the output rates R0a to R0d of the traffics Tr3 in the classes “A” to “D” from the RCC frame. To put it more specifically, the output rate obtaining circuit 104 obtains the output rates R0a to R0d of the classes “A” to “D” from the fields assigned to the rates #1 to #4 illustrated in FIG. 11B.

The output rates R0a to R0d are posted to the discard rate calculator circuit 15. In addition, the input rate obtaining circuit 14 posts the sums R3a to R3d of the input rates of the traffics Tr1 and the input rates of the traffics Tr2 in the classes “A” to “D” to the discard rate calculator circuit 15.

The discard rate calculator circuit 15 is an example of a calculation circuit, and calculates the discard rates Ra to Rd for the traffics Tr1, Tr2 in the classes “A” to “D” from: the sums R3a to R3d obtained by the input rate obtaining circuit 14; and the output rates R0a to R0d obtained by the output rate obtaining circuit 104.

In other word, unlike the discard rate calculating circuit in the communication apparatus 1 of the second comparative example, the discard rate calculator circuit 15 calculates the discard rates Ra to Rd using the output rates R0a to R0d posted in the form of the RCC frame from the communication apparatus 1 in the subsequent node #3. This makes it possible to omit the output counter 105 of the second comparative example from the communication apparatus 1 of the example, and accordingly reduces the size of the hardware.

Meanwhile, the control frame generator circuit 16 is an example of a post circuit. The control frame generator circuit 16 generates the RCC frame from the input rates R1a to R1d measured by the input counter 140, and outputs the RCC frame to the transmitter circuit 17. Thereby, the control frame generator circuit 16 posts the input rates R1a to R1d of the traffics Tr1, which is received from the previous node #1, to the communication apparatus 1 in the previous node #1. Note that the control frame generator circuit 16 obtains the input rates R1a to R1d from the input counter 140.

As discussed above, the example has been described citing the communication apparatus 1 in the node #2. The communication apparatus 1 in the subsequent node #3 also has the same configuration as does the communication apparatus 1 in the subsequent node #2. In the communication apparatus 1 in the subsequent node #3, the input counter 140 measures the input rates R1a to R1d of the traffics Tr3, which are received from the communication apparatus 1 in the previous node #2, for the respective classes “A” to “D”. Furthermore, the control frame generator circuit 16 posts the input rates R1a to R1d, which are measured by the input counter 140, to the communication apparatus 1 in the previous node #2.

To put it more specifically, the control frame generator circuit 16 incorporates the input rates R1a to R1d, which are measured by the input counter 140, into the RCC frame for checking the connection with the communication apparatus 1 in the node #2, and transmits the resultant RCC frame to the communication apparatus 1 in the node #2 via the transmitter circuit 17. Thus, using the received RCC frame, the communication apparatus 1 in the node #2 is capable of not only checking the connection with the communication apparatus 1 in the subsequent node #3, but also obtaining the output rates R0a to R0d of the traffics Tr3 which are output from the communication apparatus 1 in the node #2. Note that the communication apparatus 1 in the node #3 is an example of a first communication apparatus; and the communication apparatus 1 in the node #2 is an example of the second communication apparatus.

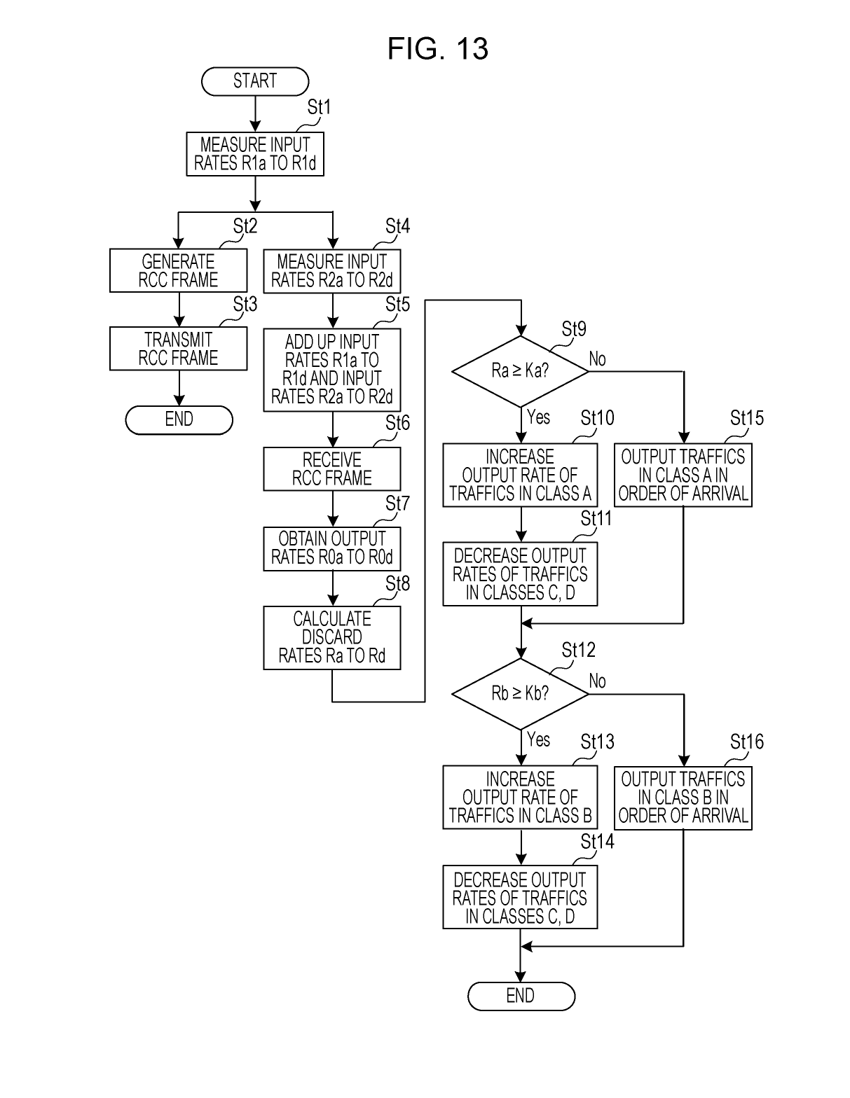

FIG. 13 is a flowchart illustrating how the communication apparatus 1 of the example works. To begin with, the input counter 140 measures the input rates R1a to R1d of the traffics Tr1, which are received from the previous node #1, for the respective classes “A” to “D” (in step St1). Note that a series of operations in subsequent steps St2, St3, and a series of operations in subsequent steps St4 to St16 are performed in parallel at the same time.

The control frame generator circuit 16 generates the RCC frame including the measured input rates R1a to R1d of the traffics Tr1 (in step St2). Thereafter, the transmitter circuit 17 transmits the generated RCC frame to the communication apparatus 1 in the previous node #1 (in step St3). Thereby, the communication apparatus 1 in the node #3 measures the input rates R1a to R1d of the traffics Tr3, which are received from the communication apparatus 1 in the previous node #2, for the respective classes “A” to “D”, and posts the measured input rates R1a to R1d to the communication apparatus 1 in the node #2.

Meanwhile, the input counter 141 measures the input rates R2a to R2d of the traffics Tr2, which are received from the terminal 22 connected to the communication apparatus 1, for the respective classes “A” to “D” (in step St4). After that, the adder circuit 142 adds up the input rates R1a to R1d of the traffics Tr1 and the input rates R2a to R2d of the traffics Tr2 for the respective classes “A” to “D”, and thereby obtains the sums R3a to R3d (in step St5).

Thereby, the communication apparatus 1 in the node #2 measures the input rates R1a to R1d of the traffics Tr1 received from the previous node #1, and the input rates R2a to R2d of the traffics Tr2 received from the terminal 22 connected to the communication apparatus 1 in the node #2. Thereafter, the communication apparatus 1 in the node #2 obtains the sums R3a to R3d of the rates R1a to R1d and the rates R2a to R2d for the respective classes “A” to “D”.

Then, the output rate obtaining circuit 104 receives the RCC frame from the communication apparatus 1 in the subsequent node #3 (in step St6). At this time, the output rate obtaining circuit 104 checks the connection with the subsequent node #3 based on the ring monitor code in the RCC frame.

Thereafter, the output rate obtaining circuit 104 obtains the output rates R0a to R0d of the traffics Tr3 of the communication apparatus 1 in the node #2 from the received RCC frame (in step St7). Subsequently, the discard rate calculator circuit 15 calculates the discard rates Ra to Rd for the traffics in the classes “A” to “D” from the sums R3a to R3d of the input rates R1a to R1d and the input rates R2a to R2d, as well as the output rates R0a to R0d posted using the RCC frame, respectively (in step St8).

After that, the read controller circuit 13 compares the discard rate Ra for the traffics Tr1, Tr2 in the class “A” with the fixed value Ka (in step St9). If Ra≧Ka (if Yes in step St9), the read controller circuit 13 reads the user frames F1a, F1a in the class “A” from the buffer 121 in order to increase the output rate of the traffic Tr3 in the class “A” (in step SUM.

Then, the read controller circuit 13 reads the user frames F1c, F2c, F1d, F2d in the classes “C” and “D” from the buffer 121 in order to decrease the output rates of the traffics Tr3 in the classes “C” and “D” (in step St11). In other words, if the discard rate Ra for the traffics Tr1, Tr2 is equal to or greater than the fixed value Ka, the read controller circuit 13 outputs the traffics Tr1, Tr2 in the class “A” more preferentially than the traffics Tr1, Tr2 in the classes “C” and “D”. Note that the processes in step St10, St11 are performed in the read control by the read controller circuit 13 controlling weighting coefficients assigned to the queues Q1a to Q1d, for example.

On the other hand, if Ra<Ka (if No in step St9), the read controller circuit 13 outputs the traffics Tr1, Tr2 in the class “A” in order of arrival of the user frames F1a, F2a in the class “A” (in step St15). In other words, if the discard rate Ra for the traffics Tr1, Tr2 in the class “A” is less than the fixed value Ka, the read controller circuit 13 outputs, regardless of the classes “A” to “D”, portions of the traffics Tr1, Tr2 in the class “A” in excess of the committed information rate set for the class “A”.

Next, the read controller circuit 13 compares the discard rate Rb for the traffics Tr1, Tr2 in the class “B” with the fixed value Kb (in step St12). If Rb≧Kb (if Yes in step St12), the read controller circuit 13 reads the user frames F1b, F2b in the class “B” from the buffer 121 in order to increase the output rate of the traffic Tr3 in the class “B” (in step St13).

Then, the read controller circuit 13 reads the user frames F1c, F2c, F1d, F2d in the classes “C” and “D” from the buffer 121 in order to decrease the output rates of the traffics Tr3 in the classes “C” and “D” (in step St14). In other words, if the discard rate Rb for the traffics Tr1, Tr2 is equal to or greater than the fixed value Kb, the read controller circuit 13 outputs the traffics Tr1, Tr2 in the classes “B” more preferentially than the traffics Tr1, Tr2 in the classes “C” and “D”. Note that the processes in step St13, St14 are performed in the read control by the read controller circuit 13 controlling the weighting coefficients assigned to the queues Q1a to Q1d, for example.

On the other hand, if Rb<Kb (if No in step St12), the read controller circuit 13 outputs the traffics Tr1, Tr2 in the class “B” in order of arrival of the user frames F1a, F2a in the class “B” (in step St16). In other words, if the discard rate Rb for the traffics Tr1, Tr2 in the class “B” is less than the fixed value Kb, the read controller circuit 13 outputs, regardless of the classes “A” to “D”, portions of the traffics Tr1, Tr2 in the class “B” in excess of the committed information rate set for the class “B”.

Thereby, out of the traffics received from the communication apparatus 1 in the previous node #1 and the terminal 22, the high-priority traffics in the classes “A” and “B” are output by the read controller circuit 13 to the communication apparatus 1 in the subsequent node #3, more preferentially depending on to the discard rates Ra, Rb for the high-priority traffics, than the low-priority traffics in the classes “C” and “D”. The communication apparatus 1 works in this manner.

As discussed above, the communication system of the example includes the communication apparatuses 1 in the nodes #2, #3 provided to the ring network configured to transmit the traffics to which the classes “A” to “D” are assigned. The communication apparatus 1 in the node #3 includes the input counter 140, and the control frame generator circuit 16.

The input counter 140 measures the input rates R0a to R0d of the traffics Tr3, received from the communication apparatus 1 in the node #2, for the respective classes “A” to “D”. The input rates R0a to R0d measured by the input counter 140 are posted as the output rates R0a to R0d of the communication apparatus 1 in the node #2 by the control frame generator circuit 16 to the communication apparatus 1 in the node #2.

Meanwhile, the communication apparatus 1 in the node #2 includes the input rate obtaining circuit 14, the discard rate calculator circuit 15, and the read controller circuit 13. The input rate obtaining circuit 14 measures the input rates R1a to R1d of the traffics Tr1 received from the previous node #1 in the ring network, and the input rates R2a to R2d of the traffics Tr2 received from the terminal 22 connected to the communication apparatus 1 in the node #2. The input rate obtaining circuit 14 obtains the sums R3a to R3d of the rates R1a to R1d and the rates R2a to R2d for the classes “A” to “D”, respectively.

The discard rate calculator circuit 15 calculates the discard rates Ra to Rd for the traffics Tr3 in the classes “A” to “D” from the sums R3a to R3d obtained by the input rate obtaining circuit 14, and the output rates R0a to R0d posted by the control frame generator circuit 16 in the communication apparatus 1 in the node #3. Out of the traffics Tr1, Tr2 received from the previous node #1 and the terminal 22, the traffics in the classes “A” and “B” are output by the read controller circuit 13 to the communication apparatus 1 in the node #3, more preferentially depending on the discard rates Ra, Rb for the traffics in the classes “A” and “B”, than the traffics in the classes “C” and “D”.

The foregoing configuration makes it possible for the communication apparatus 1 in the node #2 to calculate the discard rates Ra to Rd for the traffics Tr3 in the classes “A” to “D” based on the output rates R0a to R0d of the traffics Tr3 of the communication apparatus 1 in the node #2 which are posted by the control frame generator circuit 16 in the communication apparatus 1 in the subsequent node #3. For this reason, the communication apparatus 1 in the node #2 requests no counter configured to measure the output rates R0a to R0d.

Furthermore, the read controller circuit 13 outputs the traffics in the classes “A” and “B” to the communication apparatus 1 in the node #3 more preferentially depending on the discard rates Ra, Rb for the traffics in the classes “A” and “B”, than the traffics in the classes “C” and “D”. Thus, the communication apparatus 1 in the node #2 is capable of inhibiting the decrease in the output rates of the traffics in the classes “A” and “B”.

Accordingly, the communication system of the example is capable of performing the priority control on the traffics using the smaller-size configuration.

Meanwhile, the communication apparatus 1 of the example is provided to the node #3 in the ring network configured to transmit the traffics to which the classes “A” to “D” are assigned, and includes the input counter 140 and the control frame generator circuit 16.

The input counter 140 measures the input rates R0a to R0d of the traffics Tr3, received from the communication apparatus 1 in the previous node #2, for the respective classes “A” to “D”. The control frame generator circuit 16 incorporates the input rates R0a to R0d, measured by the input counter 140, into the RCC frame for checking the connection with the communication apparatus 1 in the node #2. The thus-incorporated input rates are posted as the output rates R0a to R0d of the communication apparatus 1 in the previous node #2 by the control frame generator circuit 16 to the communication apparatus 1 in the node #2.

The foregoing configuration makes the communication apparatus 1 in the previous node #2 informed of the output rates R0a to R0d of the traffics Tr3 of the communication apparatus 1 in the node #2 using the control frame from the control frame generator circuit 16 in the communication apparatus 1 in the node #3. Thus, the communication apparatus 1 in the node #2 is capable of performing the priority control on the traffics in the classes “A” and “B” based on the output rates R0a to R0d, although not having a counter configured to measure the output rates R0a to R0d.

Accordingly, the communication apparatus 1 of the example is capable of performing the priority control on the traffics using the smaller-size configuration.

The communication apparatus 1 of another example is provided to the node #2 in the ring network configured to transmit the traffics to which the classes “A” to “D” are assigned, and includes the input rate obtaining circuit 14, the discard rate calculator circuit 15 and the read controller circuit 13.

The input rate obtaining circuit 14 measures the input rates R1a to R1d of the traffics Tr1 received from the previous node #1 in the ring network, and the input rates R2a to R2d of the traffics Tr2 received from the terminal 22 connected to the communication apparatus 1 in the node #2. The input rate obtaining circuit 14 obtains the sums R3a to R3d of the rates R1a to R1d and the rates R2a to R2d for the classes “A” to “D”, respectively.

The discard rate calculator circuit 15 calculates the discard rates Ra to Rd for the traffics Tr3 in the classes “A” to “D” from the sums R3a to R3d obtained by the input rate obtaining circuit 14, and the output rates R0a to R0d posted by the control frame generator circuit 16 in the communication apparatus 1 in the subsequent node #3. Out of the traffics Tr1, Tr2 received from the previous node #1 and the terminal 22, the traffics in the classes “A” and “B” are output by the read controller circuit 13 to the communication apparatus 1 in the subsequent node #3, more preferentially depending on the discard rates Ra, Rb for the traffics in the classes “A” and “B”, than the traffics in the classes “C” and “D”.

The foregoing configuration makes it possible for the communication apparatus 1 in the node #2 to calculate the discard rates Ra to Rd for the traffics Tr3 in the classes “A” to “D” based on the output rates R0a to R0d of the traffics Tr3 of the communication apparatus 1 in the node #2 which are posted by the subsequent node #3. For this reason, the communication apparatus 1 in the node #2 requests no counter configured to measure the output rates R0a to R0d.

Furthermore, the read controller circuit 13 outputs the traffics in the classes “A” and “B” to the communication apparatus 1 in the node #3 more preferentially depending on the discard rates Ra, Rb for the traffics in the classes “A” and “B, than the traffics in the classes “C” and “D”. Thus, the communication apparatus 1 in the node #2 is capable of inhibiting the decrease in the output rates of the traffics in the classes “A” and “B”.

Accordingly, the communication apparatus 1 of the other example is capable of performing the priority control on the traffics using the smaller-size configuration.

Meanwhile, a traffic bandwidth control method of the example is that for the traffics which are transmitted to the ring network provided with the communication apparatuses 1 in the nodes #2, #3, and to which the classes “A” to “D” are assigned. The communication apparatus 1 in the node #3 measures the input rates R0a to R0d of the traffics Tr3, received from the communication apparatus 1 in the node #2, for the respective classes “A” to “D”. The thus-measured input rates R0a to R0d of the traffics Tr3 are posted as the output rates R0a to R0d of the communication apparatus 1 in the node #2 by the communication apparatus 1 in the node #3 to the communication apparatus 1 in the node #2.

The communication apparatus 1 in the node #2 measures the input rates R1a to R1d of the traffics Tr1 received from the previous node #1 in the ring network, and the input rates R2a to R2d of the traffics Tr2 received from the terminal 22 connected to the communication apparatus 1 in the node #2. The communication apparatus 1 in the node #2 obtains the sums R3a to R3d of the measured input rates R1a to R1d and the measured input rates R2a to R2d for the classes “A” to “D”, respectively.

Furthermore, the communication apparatus 1 in the node #2 calculates the discard rates Ra to Rd for the traffics Tr3 in the classes “A” to “D” from the obtained sums R3a to R3d, and the output rates R0a to R0d posted by the communication apparatus 1 in the node #3. Out of the traffics Tr1, Tr2 received from the previous node #1 and the terminal 22, the traffics in the classes “A” and “B” are output by the communication apparatus 1 in the node #2 to the communication apparatus 1 in the node #3 more preferentially, depending on the discard rates Ra, Rb for the traffics in the classes “A” and “B”, than the traffics in the classes “C” and “D”.

The traffic bandwidth control method of the example includes the same configuration as does the foregoing communication system, and accordingly brings about the same operation/working-effects as are discussed above.

Moreover, all or arbitrary parts of each circuit included in each apparatus may be implemented on a central processing unit (CPU), a digital signal processor (DSP), an integrated circuit (IC), a field programmable gate array (FPGA), or the like. Furthermore, all or arbitrary parts of the multiple kinds of circuits may be integrated into a single circuit, and implemented on a central processing unit (CPU), a digital signal processor (DSP), an integrated circuit (IC), a field programmable gate array (FPGA), or the like. In addition, all or arbitrary parts of the circuits may be implemented on an analysis-execution program using a CPU or the like, or on wired-logic hardware.

The foregoing embodiment is a preferable example of the present disclosure. However, the present disclosure is not limited to this embodiment. Various modifications may be made hereto without departing from the gist of the present disclosure.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A communication apparatus provided to a network that transmits traffics to which priorities are assigned, the communication apparatus comprising:
an obtainment circuit configured to measure first rates of traffics received from a previous node in the network, and second rates of traffics received from another apparatus connected to the communication apparatus, and to obtain sums of the first rates and the second rates for the respective priorities;
a calculation circuit configured to calculate discard rates for traffics for the respective priorities from the sums obtained by the obtainment circuit and rates for traffics for the respective priorities posted by a subsequent node; and
an output circuit configured to input the traffics received from the previous node and the another apparatus and to output for the subsequent node such that a certain traffic with a priority higher than a predetermined value is output more preferentially depending on the discard rate for the certain traffic, than a traffic with a priority lower than the predetermined value.

2. The communication apparatus according to claim 1,
wherein when the discard rate for a certain traffic with a priority higher than the predetermined value is equal to or greater than a fixed value, the output circuit outputs the certain traffic more preferentially than a traffics with a priority lower than the predetermined value.

3. The communication apparatus according to claim 2,
wherein when the discard rate for the certain traffic with the priority equal to or higher than the predetermined value is less than the fixed value, the output circuit outputs, regardless of the priorities, a portion of the certain traffic in excess of a committed information rate set for the priority of the certain traffic.

4. A communication system that includes a first communication apparatus and a second communication apparatus provided to a network that is configured to transmit traffics to which priorities are assigned, the communication system comprising:
the first communication apparatus includes
a measurement circuit configured to measure first rates of traffics, received from the second communication apparatus, for the respective priorities, and
a post circuit configured to post the first rates for the respective priorities, measured by the measurement circuit, to the second communication apparatus, and
the second communication apparatus includes
an obtainment circuit configured to measure second rates of traffics received from a previous node in the network, and third rates of traffics received from another apparatus connected to the second communication apparatus, and to obtain sums of the second and third rates for the respective priorities,
a calculation circuit configured to calculate discard fourth rates for the traffics for the respective priorities from the sums obtained by the obtainment circuit and the first rates posted by the post circuit, and
an output circuit configured to output traffics received from the previous node and the another apparatus to the first communication apparatus such that a certain traffic with a priority higher than a predetermined value is output more preferentially, depending on the discard rate for the certain traffic, than a traffic with a priority lower than the predetermined value.

5. The communication system according to claim 4,
wherein when the discard rate for a certain traffic with a priority higher than the predetermined value is equal to or greater than a fixed value, the output circuit outputs the certain traffic more preferentially than a traffic with a priority lower than the predetermined value.

6. The communication system according to claim 5,
wherein when the discard rate for the certain traffic with the priority equal to or higher than the predetermined value is less than the fixed value, the output circuit outputs, regardless of the priorities, a portion of the certain traffic in excess of a committed information rate set for the priority of the certain traffic.

7. The communication system according to claim 4,
wherein the post circuit is configured to incorporate the rates measured by the measurement circuit into a control frame configured to check connection with the second communication apparatus, and transmits the thus-incorporated rates to the second communication apparatus.

8. A bandwidth control method for traffics which are assigned priorities and transmitted to a network provided with a first communication apparatus and a second communication apparatus, wherein
the first communication apparatus
measures first rates of traffics, received from the second communication apparatus, for the respective priorities, and
posts the measured first rates to the second communication apparatus, and
the second communication apparatus
measures second rates of traffics received from a previous node in the network, and third rates of traffics received from another apparatus connected to the second communication apparatus,
obtains sums of the second and the third measured rates for the respective priorities,
calculates discard fourth rates for the traffics for the respective priorities from the obtained sums and the first rates posted by the first communication apparatus, and
outputs traffics received from the previous node and the another apparatus to the first communication apparatus such that a certain traffic with a priority higher than a predetermined value is output more preferentially, depending on the discard rate for the certain traffic, than a traffic with a priority lower than the predetermined value.

9. The bandwidth control method according to claim 8,
wherein when the discard rate for a certain traffic with a priority higher than the predetermined value is equal to or greater than a fixed value, the second communication apparatus outputs the certain traffic more preferentially than a traffic with a priority lower than the predetermined value

10. The bandwidth control method according to claim 9,
wherein when the discard rate for the certain traffic with the priority equal to or higher than the predetermined value is less than the fixed value, the second communication apparatus outputs, regardless of the priorities, a portion of the certain traffic in excess of a committed information rate set for the priority of the certain traffic.

11. The bandwidth control method according to claim 8,
wherein the first communication apparatus incorporates the measured rates into a control frame configured to check connection with the second communication apparatus, and transmits the thus-incorporated rates to the second communication apparatus.
